(19) United States
(12) Patent Application Publication
(10) Pub. No.: US 2026/0357973 A1
(43) Pub. Date: Nov. 12, 2026

(54) ILLUMINATION SYSTEM

(71) Applicant: ZHEJIANG MOORGEN GROUP CO., LTD., Ningbo, Zhejiang (CN)

(72) Inventors: Xun ZHANG, Ningbo, Zhejiang (CN); Zhicheng HOU, Ningbo, Zhejiang (CN)

(73) Assignee: ZHEJIANG MOORGEN GROUP CO., LTD., Ningbo, Zhejiang (CN)

(21) Appl. No.: 19/129,697

(22) PCT Filed: Dec. 27, 2024
(86) PCT No.: PCT/CN2024/143141

§ 371 Date: May 14, 2025

(30) Foreign Application Priority Data
Jan. 3, 2024 (CN) 202410010327.0

(51) Int. Cl. F21V 21/15; F21S 8/02; F21V 21/04; F21V 21/30; F21V 29/508; F21V 29/75

(52) U.S. Cl. CPC F21V 21/15; F21S 8/02; F21V 21/04; F21V 21/30; F21V 29/508; F21V 29/75

(57) ABSTRACT

An illumination system includes a lamp, a first housing, a first rotary shaft member, a first driving member, a second housing, and a second driving member. An axis of the first rotary shaft member is perpendicular to an axis of the first housing. The first driving member drives the first rotary shaft member to rotate around the axial of the first rotary shaft member and drives the first rotary shaft member to move in a radial direction of the first housing, so that the lamp is turned relative to the first housing. The second housing is rotatably connected to the first housing. The second driving member comprises a second power main body and a transmission member. The second power main body drives the transmission member, which drives the first housing, the lamp, and the first driving member to rotate about an axis of the second housing.

The present application claims the priority to Chinese Patent Application No. 2024100103270, titled “ILLUMINATION SYSTEM”, filed with the China National Intellectual Property Administration on Jan. 3, 2024, the entire content of which is incorporated herein by reference.

### FIELD

The present application relates to the technical field of illumination structures and, in particular, to an illumination system.

### BACKGROUND

The existing illumination system such as a spotlight is a common illumination device, and is mainly applied to the fields of overhead lighting, e.g., for ceiling, stage performance, museum, hotel lobby, multi-functional hall and the like.

The spotlight in the prior art has a relatively concentrated illumination beam, which can provide strong irradiation to a specific area but is limited in terms of the illumination angle, thereby affecting the application range thereof. In order to achieve multi-angle light projection, a rotatable mechanism is usually provided between the spotlight and a base. As disclosed in Chinese Patent Application No. 202221745279.2, an energy-saving LED spotlight with adjustable brightness includes a lamp tube, in which a light-emitting assembly is provided. An extension tube is fixed at one end of the lamp tube, and a flip frame is fixed at the other end of the lamp cylinder. A fixing shaft is rotatably inserted into the flip frame, and a fixing bracket is fixed onto the fixing shaft, and fitted with an inner side wall of the flip frame. A rotary threaded sleeve is provided at one end of the fixing shaft, and one side of the rotary threaded sleeve is fitted with an outer side wall of the flip frame, so that the lamp tube adjusted in angle can be positioned.

The spotlight cannot be rotated by 360° or more. In practical applications, once the rotation angle cannot meet the requirements, it will bring inconvenience to the operation, and even the lamp needs to be detached from the base and then adjusted again. Moreover, since the installation position is high, it is very inconvenient to adjust the angle once the installation is completed.

### SUMMARY

An object of the present application is to provide an illumination system, which improves the convenience of angle adjustment, also realizes multi-dimensional adjustment, and has a compact overall structure, small size, reduced cost and better use effect.

In order to solve the above technical problem, there is provided in an embodiment of the present application an illumination system.

The illumination system includes a lamp, a first housing, a first rotary shaft member, a first driving member, a second housing, and a second driving member.

The lamp is surrounded by the first housing.

The first rotary shaft member is movably connected to the first housing, and an axis of the first rotary shaft member is perpendicular to an axis of the first housing. The first rotary shaft member has an internal threaded hole.

The first driving member includes a first power main body fixed to the lamp and a lead screw connected to the first power main body. The lead screw runs through the internal threaded hole. When the first power main body drives the lead screw to rotate, the lead screw drives the first rotary shaft member to rotate around the axis of the first rotary shaft member and drives the first rotary shaft member to move in a radial direction of the first housing, so that the lamp is turned relative to the first housing.

The second housing is arranged outside the first housing and rotatably connected to the first housing.

The second driving member includes a second power main body fixed to the first housing and a transmission member connected to the second power main body. The second power main body drives the transmission member, and the transmission member drives the first housing, the lamp and the first driving member to rotate around an axis of the second housing.

Compared with the prior art, in the embodiment of the present application, since the second housing is fixed on a wall or the like as a fixing base, and the first housing is rotatably provided in the second housing, by using the second power main body to drive the transmission member, the transmission member drives the first housing together with the lamp to rotate around the axis of the first housing since the second housing is stationary. Since the first rotary shaft member is provided on the first housing, with the axis of the first rotary shaft member being perpendicular to the axis of the first housing, and the first power main body is fixed to the lamp, the first power main body drives the lead screw to rotate, which is cooperated with the first rotary shaft member so that the first rotary shaft member is rotated and moved in the radial direction. The first rotary shaft member drives the lamp to turn, so that the angle of light emitted from the lamp is changed. At the same time, the lamp can rotate around the axis of the first housing. As a result, multi-dimensional adjustment of the emitted light is realized. The structures of the first housing and the second housing are fully fitted, so the overall structure is compact and simple, and the overall design is smart and exquisite. The illumination system is not complicated in structure and not large in size compared with the prior art in which too many brackets are provided for turning the lamp.

In an embodiment, the first housing is formed with a pair of limiting slots spaced apart from each other in a circumferential direction of the first housing, and each of the limiting slots extends radially.

Two ends of the first rotary shaft member are respectively provided in the pair of limiting slots. The first rotary shaft member is provided in such a manner as to be slidable in an extension direction of the limiting slots and rotatable in the limiting slots.

In an embodiment, a limiting block is provided in the limiting slot for limiting the first rotary shaft member, and the first rotary shaft member abuts against the limiting block when the first rotary shaft member slides to a predetermined position.

In an embodiment, the lamp includes a lamp body and a heat dissipation member fixed to the lamp body. The first driving member is fixed to the heat dissipation member.

In an embodiment, the heat dissipation member covers one side of the lamp body facing away from the second housing.

A peripheral side wall of the heat dissipation member is formed with a groove, and the first power main body is provided in the groove.

In an embodiment, the second power main body is mounted at a top of the first housing.

The peripheral side wall of the heat dissipation member is further formed with an avoidance groove for accommodating the second power main body, and the avoidance groove extends through the heat dissipation member toward the top of the first housing.

In an embodiment, the transmission member is meshingly connected to an inner wall of the second housing.

In an embodiment, a surface of the inner wall of the second housing is a toothed surface.

The transmission member is a meshing wheel extending in an axis direction of the first housing, and the meshing wheel is fixedly connected to a main shaft of the second power main body. The first housing is formed with a notch for placing the meshing wheel, and a protruding shaft inserted into the meshing wheel is provided in the notch, and the meshing wheel is rotatably arranged on the protruding shaft.

In an embodiment, the lamp body further includes a body member and a lampshade fixed to the body member. The heat dissipation member is fixed to the lampshade and the body member, and covers one side of the body member facing away from the second housing.

The lampshade is at least partially inserted into the first housing and connected to the first housing by means of a connecting shaft, an axis direction of the connecting shaft being the same as an axis direction of the first transmission shaft, and the lampshade is rotatably connected to the connecting shaft.

A light gathering hood corresponding to the lamp is further provided in the second housing, and a fixing bracket for positioning is fixedly connected to the second housing.

In an embodiment, the top of the first housing has an avoidance part for providing space for the lamp.

In an embodiment, at least one of an inner wall of the first housing and an outer wall of the second housing is provided with universal balls, and the other of the inner wall of the first housing and the outer wall of the second housing is provided with a track for the universal balls to roll.

In an embodiment, the first rotary shaft member has an internal threaded hole, and the first driving member includes a first power main body fixed to the lamp and a lead screw connected to the first power main body. The lead screw runs through the internal threaded hole. When the first power main body drives the lead screw to rotate, the lead screw drives the first rotary shaft member to rotate around the axis of the first rotary shaft member and drives the first rotary shaft member to move in the radial direction of the first housing.

In an embodiment, the first driving member includes a linear motor, and a main shaft of the linear motor is fixed to the first rotary shaft member and is perpendicular to the axis of the first rotary shaft member.

The linear motion of the main shaft of the linear motor drives the first rotary shaft member to rotate around the axis thereof and drives the first rotary shaft member to move in the radial direction of the first housing.

### BRIEF DESCRIPTION OF THE DRAWINGS

One or more embodiments are illustratively described in conjunction with the accompanying drawings corresponding to the embodiments. The illustrative descriptions are not intended to limit the embodiments. In the accompanying drawings, elements indicated by the same reference numerals are represented as similar elements. The accompanying drawings do not limit the scale unless otherwise stated.

FIG. 1 is a schematic structural view of an illumination system according to an embodiment of the present application;

FIG. 2 is a section view of an illumination system according to an embodiment of the present application when viewed from an angle;

FIG. 3 is a section view of an illumination system according to an embodiment of the present application when viewed from another angle; and

FIG. 4 is a schematic structural view showing cooperation of a first housing, a transmission member, and a second housing according to an embodiment of the present application.

List of reference numerals in the accompanying drawings:

| | | |
|---|---|---|
| 100. illumination | 1. lamp; | 11. lamp body; |
| system; | | |
| 111. body member; | 112. lampshade; | 12. heat dissipation |
| | | member; |
| 120. groove; | 121. avoidance groove; | 2. first housing; |
| 21. limiting slot; | 22. notch; | 23. protruding shaft; |
| 24. avoidance part; | 3. first rotary shaft | 30. internal threaded |
| | member; | hole; |
| 4. first driving member; | 41. first power main | 42. lead screw; |
| | body; | |
| 5. second housing; | 50. meshing surface; | 6. second driving |
| | | member; |
| 61. second power main | 62. transmission | |
| body; | member; | |
| X. axis of first housing; | 7. fixing bracket; | |
| 8. light gathering hood; | 91. universal ball; | |
| 92. spring; | 93. connecting shaft. | |

### DETAILED DESCRIPTION OF THE EMBODIMENTS

In order to make the objects, technical solutions, and advantages of the embodiments of the present application more clear, the embodiments of the present application will be described below in detail with reference to the accompanying drawings. However, it can be understood by those skilled in the art that many technical details are set forth in various embodiments of the present application in order to make the reader better understand the present application. However, even without these technical details and various changes and modifications based on the following embodiments, the technical solutions claimed in the present application may also be implemented.

In the following description, for purposes of explaining various disclosed embodiments, certain specific details are set forth in order to provide a thorough understanding of various disclosed embodiments. However, those skilled in the relevant art will recognize that embodiments may be practiced without one or more of these specific details. In other instances, well-known devices, structures, and techniques associated with the present application may not be shown or described in detail so as to avoid unnecessarily obscuring the description of the embodiments.

Unless otherwise required in the context, throughout the specification and claims, the words “including” and variations thereof, such as “comprising” and “having” should be understood in an open and inclusive sense, i.e., should be interpreted as “including, but not limited to”.

The various embodiments of the present application will be described in detail below with reference to the accompanying drawings, so as to understand the objects, features and advantages of the present application more clearly. It should be understood that the embodiments shown in the accompanying drawings are not intended to limit the scope of the present application, but are merely intended to illustrate the spirit of the technical solutions of the present application.

Reference to “one embodiment” or “an embodiment” throughout the present application means that a particular characteristic, structure, or feature described in conjunction with the embodiment is included in at least one embodiment. Thus, the different appearances of the phrases “in one embodiment” or “in an embodiment” throughout the specification are not necessarily all referring to the same embodiment. Furthermore, the particular characteristics, structures, or features may be combined in any manner in one or more embodiments.

The singular forms “a” or “an” and “the” as used in this specification and the appended claims include plural referents, unless expressly stated otherwise in the context. It should be noted that the term “or” is usually used in the sense that it includes “and/or” unless expressly stated otherwise in the context.

In the following description, in order to clearly illustrate the structure and working mode of the present application, multiple directional words are used for description, but terms such as “front”, “rear”, “left”, “right”, “outer”, “inner”, “outward”, “inward”, “upper”, and “lower” should be understood as convenient terms, and should not be understood as limiting terms.

Embodiments of the present application are described below with reference to the accompanying drawings.

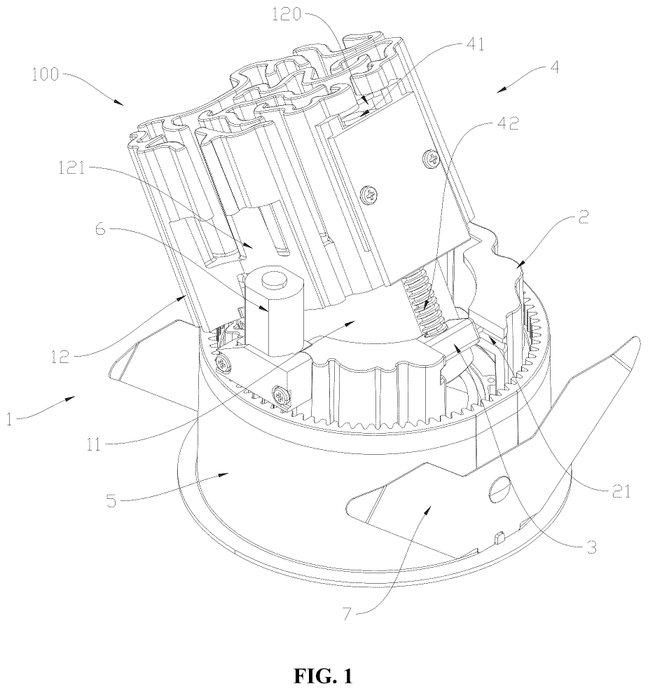

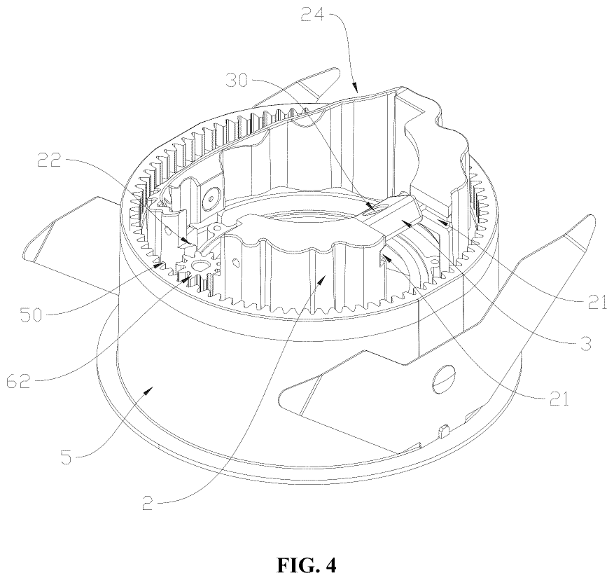

An embodiment of the present application relates to an illumination system 100. As shown in FIGS. 1, 2, 3 and 4, the illumination system 100 may be a spotlight or a downlight, and the illumination system 100 includes a lamp 1, a first housing 2, a first rotary shaft member 3, a first driving member 4, a second housing 5 and a second driving member 6. A bottom of the second housing 5 is formed as a light outlet. When in use, the second housing 5 may be fixed on a ceiling or a wall, so that the second housing 5 serves as a fixing base. The lamp 1 is movable relative to the second housing 5 to adjust the emitted light. The lamp 1 is surrounded by the first housing 2. The first rotary shaft member 3 is movably connected to the first housing 2, and an axis of the first rotary shaft member 3 is perpendicular to an axis of the first housing 2. The first rotary shaft member 3 has an internal threaded hole 30. The first driving member 4 includes a first power main body 41 fixed to the lamp 1 and a lead screw 42 connected to the first power main body 41. The lead screw 42 runs through the internal threaded hole 30, and is threadedly engaged with the internal threaded hole 30. When the first power main body 41 drives the lead screw 42 to rotate, the lead screw 42 drives the first rotary shaft member 3 to rotate around an axis of the first rotary shaft member 3 and drives the first rotary shaft member 3 to move in a radial direction of the first housing 2, so that the lamp 1 is turned relative to the first housing 2. The second housing 5 is arranged outside the first housing 2 and rotatably connected to the first housing 2. The second driving member 6 includes a second power main body 61 fixed to the first housing 2, and a transmission member 62 connected to the second power main body 61. The second power main body 61 drives the transmission member 62, and the transmission member 62 drives the first housing 2, the lamp 1 and the first driving member 4 to rotate about an axis of the second housing 5.

In other embodiments, the first driving member may include a linear motor. A main shaft of the linear motor may be directly or indirectly connected to the first rotary shaft member and be perpendicular to the axis of the first rotary shaft member. The linear motion of the main shaft of the linear motor drives the first rotary shaft member to rotate around the axis thereof, and drives the first rotary shaft member to move in the radial direction of the first housing.

In this embodiment, the first housing 2 and the second housing 5 are coaxially provided. The axis direction of the first housing 2 and the second housing 5 is defined as a longitudinal direction, and the axis direction of the first rotary shaft member 3 is defined as a transverse direction.

From the above, it can be known that the second housing 5 is fixed on a wall or the like, and is positioned as a fixing base, and the first housing 2 is rotatably provided in the second housing 5. Thus, the second power main body 61 drives the transmission member 62, and the transmission member 62 in turn drives the first housing 2 together with the lamp 1 to rotate around the axis of the first housing 2 since the second housing 5 is stationary. The first rotary shaft member 3 is provided on the first housing 2, with the axis of the first rotary shaft member 3 being perpendicular to the axis of the first housing 2, and the first power main body 41 is fixed to the lamp 1. Thus, the first power main body 41 drives the lead screw to rotate, and the lead screw is cooperated with the first rotary shaft member 3, so that the first rotary shaft member 3 is rotated and moved in the radial direction. The first rotary shaft member 3 drives the lamp 1 to turn, so that the angle of light emitted from the lamp 1 is changed. And, the lamp 1 can rotate around the axis of the first housing 2. Therefore, multi-dimensional adjustment of the emitted light is realized. The structures of the first housing 2 and the second housing 5 are fully fitted, so the overall structure is compact and simple, and the overall design is smart and exquisite. The illumination system 100 is neither complicated in structure nor large in size compared with the prior art in which too many brackets are provided for turning the lamp.

The implementation details of this embodiment are specifically described below, and the following is merely provided for ease of understanding, and is not necessary to implement this solution.

As shown in FIGS. 1 to 4, a fixing bracket 7 for positioning is fixed on the second housing 5, and the second housing 5 is fixed on the ceiling or the wall by the fixing bracket 7. A light gathering hood 8 corresponding to the lamp 1 is further provided in the second housing 5. The lamp 1 is rotatably connected to the first housing 2 by means of a connecting shaft 93, an axis of the connecting shaft 93 being perpendicular to an axis of the first housing 2, and an axis direction of the connecting shaft 93 being the same as an axis direction of the first transmission shaft. When the lamp 1 is turned, the lamp 1 rotates around the connecting shaft 93, that is, an angle between the axis of the lamp 1 and the axis of the first housing 2 is changed.

Further, as shown in FIGS. 1 to 4, the first housing 2 is provided with a pair of limiting slots 21 spaced apart from each other in a circumferential direction of the first housing 2. Each of the limiting slots 21 extends radially. Two ends of the first rotary shaft member 3 are respectively provided in the pair of limiting slots 21, and the first rotary shaft member 3 is slidably provided in an extension direction of the limiting slots 21 and rotatably disposed in the limiting slots 21.

Furthermore, as shown in FIGS. 1 to 4, in order to limit the range of the turning angle of the lamp 1, a limiting block (not shown) may be provided in the limiting slot 21 to limit the position of the first rotary shaft member 3. The first rotary shaft member 3 abuts against the limiting block when sliding to a predetermined position.

Further, as shown in FIGS. 1 to 4, the lamp 1 includes a lamp body 11 and a heat dissipation member 12 fixed to the lamp body 11. The first driving member 4 is fixed to the heat dissipation member 12.

Further, as shown in FIGS. 1 to 4, the heat dissipation member 12 covers the side of the lamp body 11 facing away from the second housing 5, that is, the heat dissipation member 12 is located at the top of the lamp body 11, so as to cover more regions of the lamp body 11 to realize better heat dissipation. A peripheral side wall of the heat dissipation member 12 is provided with a groove 120, and the first power main body 41 is provided in the groove 120. Thus, the overall structure is more compact, and the illumination system 100 has a smaller size.

Further, as shown in FIGS. 1 to 4, the second power main body 61 is mounted at the top of the first housing 2. The peripheral side wall of the heat dissipation member 12 is further provided with an avoidance groove 121 for accommodating the second power main body 61. The avoidance groove 121 extends through the heat dissipation member 12 toward the top of the first housing 2. As such, the overall structure is more compact, and the illumination system 100 has a smaller size.

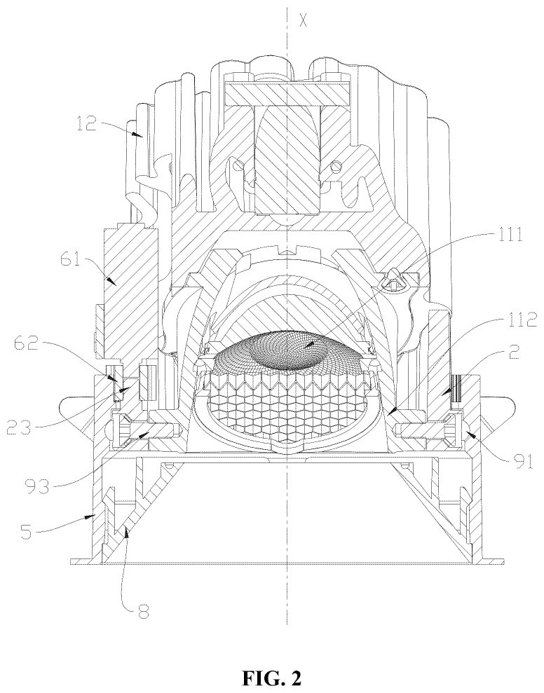

Moreover, as shown in FIGS. 2 to 4, the transmission member 62 is engaged with an inner wall of the second housing 5.

Further, as shown in FIGS. 1 to 4, the inner wall of the second housing 5 has a toothed surface 50. The transmission member 62 is a meshing wheel extending in the axis direction of the first housing 2, and the meshing wheel is fixedly connected to a main shaft of the second power main body 61. The first housing 2 is provided with a notch 22 for placing the meshing wheel. A protruding shaft 23 is provided in the notch 22 and configured to be inserted into the meshing wheel. The meshing wheel is rotatably arranged on the protruding shaft 23. The second housing 5 is fixed and positioned. The meshing wheel is engaged with the meshing surface when rotating, so that the first housing 2 is driven to rotate around its axis since the second housing 5 where the meshing surface is located is stationary. The axis of the connecting shaft 93 is perpendicular to the axis of the second housing 5, and the connecting shaft 93 connects the first housing 2 and the lamp 1, so that the lamp 1 can be driven by the first housing 2 to rotate around the axis direction of the second housing 5.

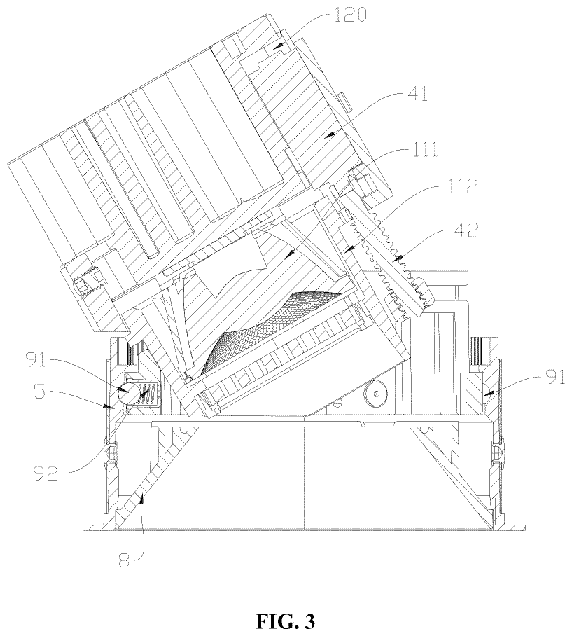

Furthermore, as shown in FIGS. 2 and 3, in order to allow the first housing 2 to rotate smoothly in the second housing 5, universal balls 91, i.e., 360-degree rotatable balls are embedded in an outer wall of the first housing 2, and a circumferential track is provided on the inner wall of the second housing 5. When the first housing 2 rotates in the second housing 5, the universal balls 91 roll along the track. A spring 92 is provided in the groove where the universal ball 91 is placed. Two ends of each spring 92 respectively abut against the universal ball 91 and the groove bottom (i.e., the second housing 5). In other embodiments, the positions of the universal balls 91 and the track may be exchanged.

Further, as shown in FIGS. 2 and 3, the lamp body 11 further includes a body member 111 and a lampshade 112 fixed to the body member 111. The heat dissipation member 12 is fixed to the lampshade 112 and the body member 111, and covers the side of the body member 111 facing away from the second housing 5. The lampshade 112 is at least partially inserted into the first housing 2. The connecting shaft 93 connects the first housing 2 and the lampshade 112, and the lampshade 112 is rotatably connected to the connecting shaft 93.

Furthermore, as shown in FIGS. 2 and 3, a light gathering hood 8 corresponding to the lamp 1 is further disposed in the second housing 5.

Further, as shown in FIGS. 1 to 4, the top of the first housing 2 has an avoidance part 24 for providing space for the lamp 1. When the lamp 1 is turned by a certain angle, the lamp 1 is partially located in the avoidance part 24.

Specifically, FIGS. 1 and 2 show the limit position of the lamp 1 when it is turned. If the lamp 1 needs to be vertical, the first power main body 41 is controlled to rotate, such that the lead screw 42 passes more through the internal threaded hole 30. The first housing 2 is fixed relative to the second housing 5 and does not rotate. The first rotary shaft member 3 is rotated outwards, and simultaneously slides outwardly along the limiting slots 21, i.e., the first rotary shaft member 3 slides away from the axis direction of the first housing 2 until a rectangular block in the middle of the first rotary shaft member 3 is rotated to a horizontal orientation. That is, an axis of the internal threaded hole 30 is vertical, and the lamp 1 is also vertical.

While preferred embodiments of the present application have been described in detail above, it should be understood that that some aspects of the embodiments can be modified to adopt aspects, features and concepts of the various patents, applications, and publications in order to provide additional embodiments if necessary.

These and other variations can be made to the embodiments in view of the above detailed description. In general, the terms used in the claims should not be considered to be limited to the specific embodiments disclosed in the specification and the claims, but should be understood to include all possible embodiments along with all the equivalent scope defined by these claims.

It can be understood by those skilled in the art that the above embodiments are specific examples for implementing the present application, and in practical applications, various changes can be made in form and detail without departing from the spirit and scope of the present application.

1. An illumination system, comprising:
a lamp;
a first housing, which surrounds the lamp;
a first rotary shaft member movably connected to the first housing, with an axis of the first rotary shaft member being perpendicular to an axis of the first housing;
a first driving member configured to drive the first rotary shaft member to rotate about the axis of the first rotary shaft member, and to drive the first rotary shaft member to move in a radial direction of the first housing, so that the lamp is turned relative to the first housing;
a second housing provided outside the first housing and rotatably connected to the first housing; and
a second driving member comprising: a second power main body fixed to the first housing; and a transmission member connected to the second power main body, wherein the second power main body is configured to drive the transmission member, so that the transmission member drives the first housing, the lamp and the first driving member to rotate about an axis of the second housing.

2. The illumination system according to claim 1, wherein the first housing is provided with a pair of limiting slots spaced apart from each other in a circumferential direction of the first housing, and each of the limiting slots extends radially; and
two ends of the first rotary shaft member are respectively provided in the pair of limiting slots in such a manner as to be slidable in an extension direction of the limiting slots and rotatable in the limiting slots.

3. The illumination system according to claim 2, wherein a limiting block is provided in the limiting slot and is configured to limit the first rotary shaft member, and the first rotary shaft member abuts against the limiting block when the first rotary shaft member slides to a predetermined position.

4. The illumination system according to claim 1, wherein the lamp comprises a lamp body, and a heat dissipation member fixed to the lamp body, and the first driving member is fixed to the heat dissipation member.

5. The illumination system according to claim 4, wherein the heat dissipation member covers a side of the lamp body facing away from the second housing; and
a groove is provided on a peripheral side wall of the heat dissipation member, and the first power main body is provided in the groove.

6. The illumination system according to claim 4, wherein the second power main body is mounted at a top of the first housing;
an avoidance groove is further provided on the peripheral side wall of the heat dissipation member, is configured to accommodate the second power main body, and extends through the heat dissipation member towards the top of the first housing.

7. The illumination system according to claim 1, wherein the transmission member is meshingly connected to an inner wall of the second housing.

8. The illumination system according to claim 7, wherein the inner wall of the second housing has a toothed surface;
the transmission member is a meshing wheel extending in an axis direction of the first housing, and the meshing wheel is fixedly connected to a main shaft of the second power main body; and
the first housing is provided with a notch for placing the meshing wheel, a protruding shaft is provided in the notch and configured to be inserted into the meshing wheel, and the meshing wheel is rotatably arranged on the protruding shaft.

9. The illumination system according to claim 4, wherein the lamp body further comprises a body member, and a lampshade fixed to the body member;
the heat dissipation member is fixed to the lampshade and the body member, and covers a side of the body member facing away from the second housing;
the lampshade is at least partially inserted into the first housing and connected to the first housing via a connecting shaft, an axis direction of the connecting shaft is the same as an axis direction of the first transmission shaft, and the lampshade is rotatably connected to the connecting shaft; and
a light gathering hood corresponding to the lamp is further arranged in the second housing; and a fixing bracket is fixed on the second housing to position the second housing.

10. The illumination system according to claim 1, wherein the first rotary shaft member has an internal threaded hole;
the first driving member comprises a first power main body fixed to the lamp, and a lead screw connected to the first power main body and running through the internal threaded hole; and
the lead screw is configured to, when the first power main body drives the lead screw to rotate, drive the first rotary shaft member to rotate around the axis of the first rotary shaft member and drive the first rotary shaft member to move in the radial direction of the first housing.
